(19) United States
(12) Patent Application Publication
(10) Pub. No.: US 2026/0362017 A1
(43) Pub. Date: Nov. 12, 2026

(54) IMAGE PROCESSING APPARATUS, IMAGING APPARATUS AND CONTROL METHOD THEREOF, AND STORAGE MEDIUM STORING PROGRAM

(71) Applicant: CANON KABUSHIKI KAISHA, Tokyo (JP)

(72) Inventor: KAZUKI SATO, Kanagawa (JP)

(21) Appl. No.: 19/644,571

(22) Filed: Apr. 10, 2026

(30) Foreign Application Priority Data
May 9, 2025 (JP) 2025-078493

(51) Int. Cl. H04N 23/76; H04N 23/62; H04N 23/63; H04N 23/667; H04N 23/73

(52) U.S. Cl. CPC H04N 23/76; H04N 23/62; H04N 23/631; H04N 23/635; H04N 23/667; H04N 23/73

(57) ABSTRACT

An apparatus includes an acquisition unit configured to acquire an image, a setting unit configured to set an area in the image to which a dimming effect is to be applied, a calculation unit configured to calculate an evaluation value for the image, a photometry unit configured to perform light metering on the image, and a correction unit configured to correct the evaluation value based on a setting of the area to which the dimming effect is to be applied, wherein the photometry unit uses the corrected evaluation value to perform light metering on a priority basis in either the area to which the dimming effect is to be applied or an area other than the area to which the dimming effect is to be applied.

### BACKGROUND

### FIELD OF TECHNOLOGY

The aspect of the embodiments relates to an image processing apparatus, an imaging apparatus and a control method thereof, and a storage medium storing a program.

### DESCRIPTION OF THE RELATED ART

When a subject with a high contrast is photographed at long exposure, some areas of the subject in the captured image may be appropriately bright and others may have a whiteout. A method for improving this situation is to use a half neutral density (ND) filter, an optical member that dims bright areas of the subject in the image to reduce the contrast of the subject. Patent Document 1 describes a function for simulating the dimming effect of a half ND filter by image processing in a camera.

According to Japanese Patent Laid-Open No. 2024-013938, in the case of performing automatic exposure control in conventional ND filter photography or pseudo-ND filter photography, the automatic exposure control is carried out through light metering of the entire area including the dimmed and non-dimmed areas, depending on the photometry method set in the camera. As a result, the exposure control may be unintended by the user, and the same issue may occur with the pseudo half ND filter function implemented in the camera.

### SUMMARY

According to an aspect of the embodiments, an apparatus includes an acquisition unit configured to acquire an image, a setting unit configured to set an area in the image to which a dimming effect is to be applied, a calculation unit configured to calculate an evaluation value for the image, a photometry unit configured to perform light metering on the image, and a correction unit configured to correct the evaluation value based on a setting of the area, wherein the photometry unit uses the corrected evaluation value to perform light metering based on a priority in either the area or an area other than the area to which the dimming effect is to be applied.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an imaging apparatus according to an embodiment.

FIG. 2 is a flowchart illustrating a control process according to the embodiment.

FIG. 3 is a diagram for describing an example of imaging conditions.

FIGS. 4A and 4B are diagrams illustrating an example of gradation of a gradation neutral density (GND) filter.

FIGS. 5A and 5B are diagrams for describing setting of gradation information.

FIGS. 6A to 6C are diagrams for describing an example of determining a gradation density level.

FIG. 7 is a diagram illustrating the distance from a gradation center line and characteristics of the gradation density level in FIGS. 6A to 6C.

FIGS. 8A to 8C are diagrams for describing an example of multiplying gradations.

FIG. 9 is a diagram for describing an example of a curve for calculating gains from gradation information.

FIGS. 10A to 10F are diagrams for describing gain correction to a photometric evaluation value.

FIG. 11 is a diagram for describing a photometry area based on gradation information.

### DESCRIPTION OF THE EMBODIMENTS

Hereinafter, embodiments will be described in detail with reference to the accompanying drawings. Note that the following embodiments do not limit the disclosure according to the claims. Although a plurality of features is described in the embodiments, not all of the plurality of features are necessarily essential to the disclosure, and the plurality of features may be combined arbitrarily. Furthermore, in the accompanying drawings, identical reference numerals are given to identical or similar components, and redundant descriptions will be omitted.

The following describes an embodiment in which an image processing apparatus of the disclosure is applied to a digital camera that has a function of simulating the dimming effect of a half neutral density (ND) filter through image processing.

The image processing apparatus of the disclosure is not limited to a digital camera, but may also be applied to electronic devices with an imaging function, such as a smartphone, which is a type of mobile phone, and a tablet terminal.

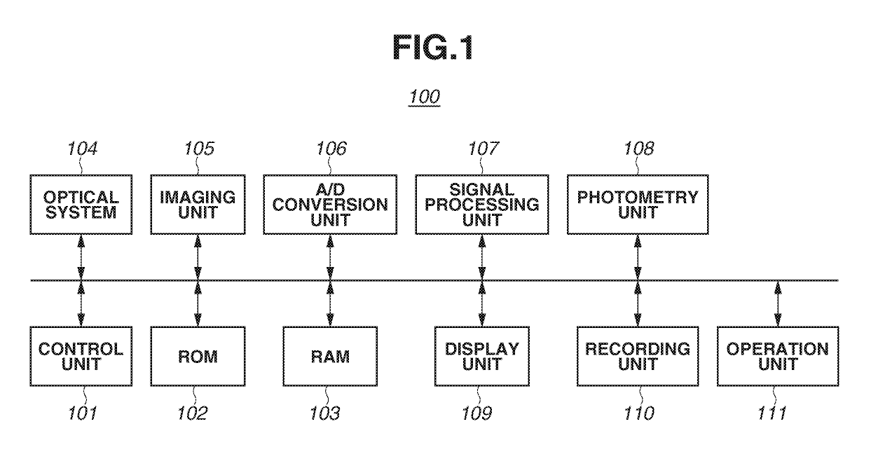

First, a configuration and functions of an imaging apparatus equipped with an image processing apparatus according to the embodiment will be described with reference to FIG. 1.

FIG. 1 is a block diagram illustrating a configuration of an imaging apparatus 100 according to the embodiment. In the imaging apparatus 100 illustrated in FIG. 1, the components (blocks) of the imaging apparatus 100 are connected via a bus, for example.

A control unit 101 is a central processing unit (CPU), for example, and reads out a control program for each block included in the imaging apparatus 100 from a read only memory (ROM) 102 described below, develops the program into a random access memory (RAM) 103 described below, and executes the program to control the operation of each block of the imaging apparatus 100. The ROM 102 is a rewritable non-volatile memory, and stores parameters and the like necessary for the operation of each block in addition to the control program for each block of the imaging apparatus 100. The RAM 103 is a rewritable volatile memory, and is used as a temporary storage area for data generated by the operation of each block of the imaging apparatus 100.

An optical system 104 consists of a lens group including a zoom lens and a focus lens, an aperture, a shutter, and the like. The optical system 104 forms an optical image of a subject or the like on an imaging surface of an imaging unit 105. The lens unit in which the lens group and the aperture constituting the optical system 104 are integrated may be detachable from the imaging apparatus 100, or may be integrated with the imaging apparatus 100.

The imaging unit 105 is an imaging element such as a charge-coupled device (CCD) or complementary metal-oxide semiconductor (CMOS) sensor, which photoelectrically converts an optical image formed on the imaging surface by the optical system 104 and sequentially outputs the obtained analog image signals to an analog/digital (A/D) conversion unit 106. The imaging unit 105 may have a Bayer array configuration in which R, G1, G2, and B pixels are regularly arranged.

The A/D conversion unit 106 converts the input analog image signal into digital image data and outputs the obtained digital image data to the RAM 103. The RAM 103 temporarily stores the image data supplied from the A/D conversion unit 106.

A signal processing unit 107 performs various types of signal processing such as white balance adjustment, color interpolation, gamma processing, noise reduction processing, and brightness correction using gains on the image data temporarily stored in the RAM 103. The signal processing unit 107 may also be configured to perform various types of image conversion processing. Each processing in the signal processing unit 107 may be implemented by a CPU or the like executing a program.

A photometry unit 108 measures the brightness of the subject from the imaging data converted by the A/D conversion unit 106, and determines exposure settings (shutter speed, lens aperture, International Organization for Standardization (ISO) sensitivity) based on the measurement results such that the subject has a target exposure. Exposure correction is performed by controlling the exposure time, ISO sensitivity, and aperture of the imaging unit 105 based on the exposure settings determined by the photometry unit 108.

A display unit 109 is a display device such as a liquid crystal display (LCD). Images recorded in the RAM 103 or a recording unit 110 (described below), operation user interface (UI) images for receiving instructions from a user, and the like are displayed on the screen of the display unit 109. The display unit 109 also displays a live view captured by the imaging unit 105.

The display unit 109 may display an imaging mode selection screen, a menu screen, and settings for imaging conditions such as the imaging mode, ISO sensitivity, aperture value, shutter speed, and gradation neutral density (GND) density.

The recording unit 110 records raw images, image data developed by the signal processing unit 107, raw images composited by the signal processing unit 107, and the like.

An operation unit 111 is a UI unit that includes a touch sensor provided on the screen of the display unit 109, various buttons provided on the housing of the imaging apparatus 100, a shutter button that is mainly operated in capturing an image, and the like, for example.

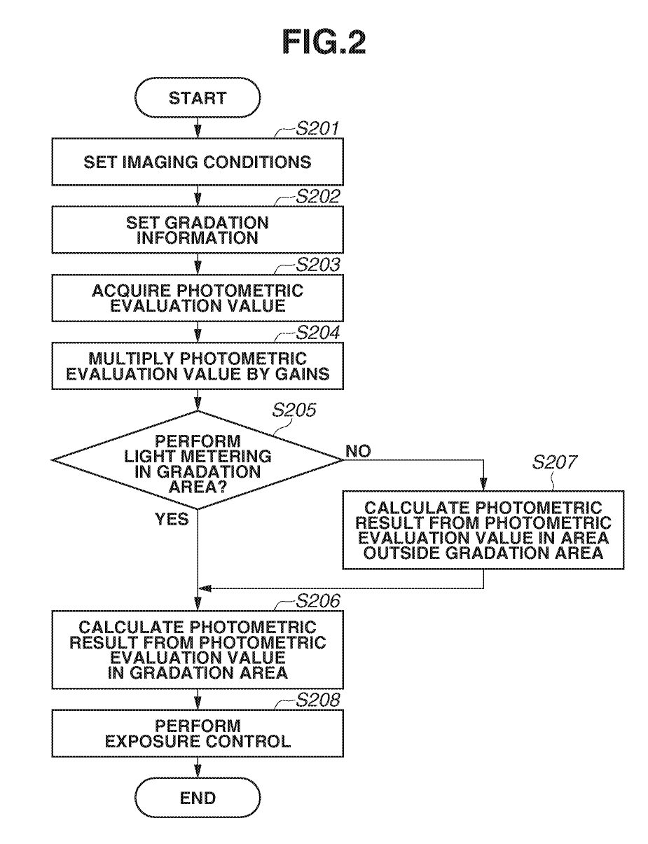

FIG. 2 is a flowchart for describing exposure control in the GND filter (half ND filter) function. Each step illustrated in the flowchart in FIG. 2 is implemented by the control unit 101 controlling each unit of the imaging apparatus 100 based on a program stored in the ROM 102, and controlling input to the signal processing unit 107 and output from the signal processing unit 107.

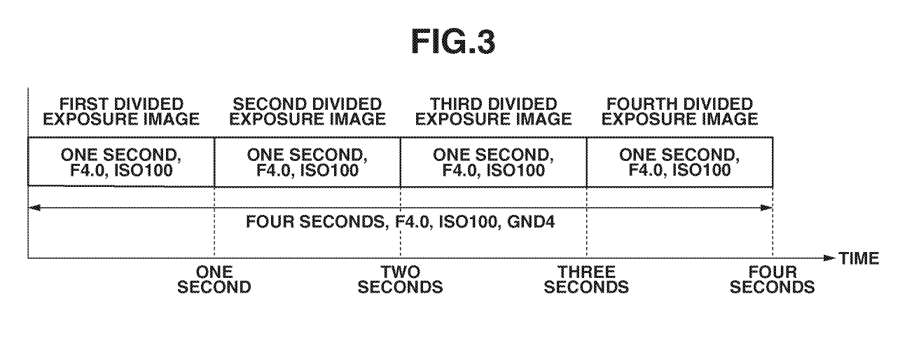

First, in step S201, the control unit 101 sets the imaging conditions for capturing an image in the imaging apparatus 100. Hereinafter, the setting of the imaging conditions by the control unit 101, particularly the exposure conditions, will be described in detail with reference to FIG. 3.

FIG. 3 is a diagram illustrating an example of imaging conditions. FIG. 3 schematically illustrates an example of setting imaging conditions in a case where, as exposure conditions, the shutter speed is set to four seconds, the aperture is set to F4.0, the ISO sensitivity is set to ISO100, and the GND density is set to GND4.

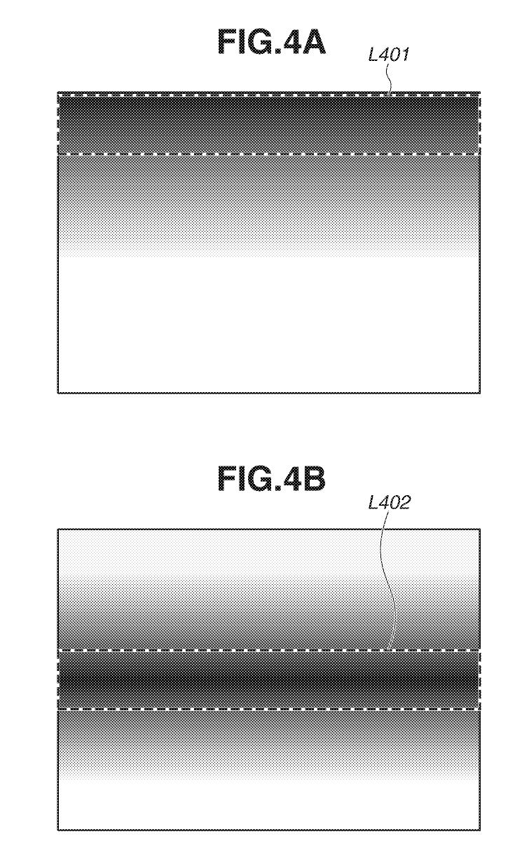

The GND density will be described in detail with reference to FIGS. 4A and 4B. As illustrated in FIG. 4A, a physical GND filter provides a gradation from the transparent lower portion to the upper portion, gradually reducing subject light. The GND density indicates the maximum degree of dimming (dimming intensity) of the GND filter. In FIG. 4A, an area L401 corresponds to the maximum dimming part. The GND2 indicates one stage of maximum dimming, GND4 indicates two stages of maximum dimming, and GND8 indicates three stages of maximum dimming. The GND0.3 may also be expressed as one stage of dimming, GND0.6 as two stages of dimming, and GND0.9 as three stages of dimming. Furthermore, some physical GND filters provide a gradation from the center in both upward and downward directions, as illustrated in FIG. 4B. The maximum dimming part in FIG. 4B is an area L402.

Returning to the description with reference to FIG. 3, in the embodiment, no physical GND filter is used, and a GND filter effect is produced through image processing. Therefore, dimming exposure is compensated for by shortening the shutter speed. Accordingly, the control unit 101 sets the aperture and ISO determined by the camera's automatic exposure control as imaging conditions, but shortens the shutter speed set by the automatic exposure control by the amount of dimming due to the GND density. Specifically, as illustrated in FIG. 3, when the shutter speed is four seconds and the GND density is GND4, two stages of dimming are required. Therefore, the control unit 101 shortens the shutter speed by two stages to one second and sets the same as an imaging condition for the divided exposure images. Furthermore, the control unit 101 sets the number of images to be captured such that the combined exposure time of the plurality of divided exposure images is equivalent to the shutter speed set by the automatic exposure control. In the example illustrated in FIG. 3, the exposure time of one divided exposure image is one second, and the shutter speed set by the automatic exposure control is four seconds, so the control unit 101 sets the number of images to be captured to four.

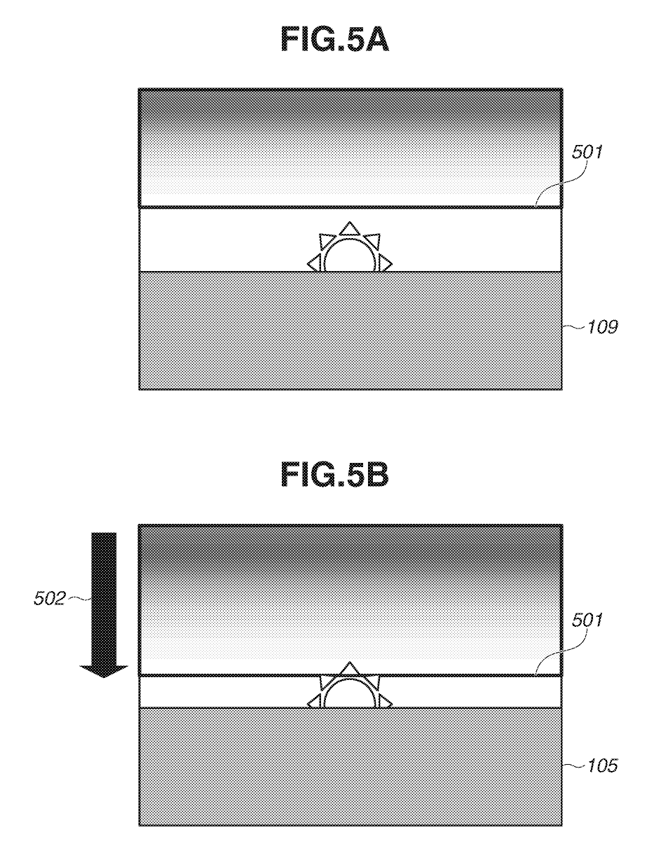

Returning to FIG. 2, in step S202, the control unit 101 sets gradation information. This process is implemented by the control unit 101 controlling the settings of the imaging apparatus 100 based on a user operation using the operation unit 111. Hereinafter, a method for setting gradation information will be described in detail with reference to FIGS. 5A, 5B, 6A to 6C and 7.

First, upon receipt of an instruction to set gradation information in step S202, the control unit 101 controls the display unit 109 to display a gradation information setting UI. In the gradation information setting UI displayed on the display unit 109, a gradation center line 501 is superimposed on a captured image as illustrated in FIG. 5A, for example. The user can specify the position of the gradation center line 501 by moving or rotating the gradation center line 501 using the operation unit 111. For example, FIG. 5B illustrates a state in which the gradation center line 501 has been moved downward from the state illustrated in FIG. 5A, as indicated by arrow 502.

Next, the control unit 101 determines the gradation density level for each coordinates on the image based on the gradation center line 501 specified by the user. The gradation density level refers to the degree to which the gradation is expressed, from 0% being the lightest to 100% being the darkest. Furthermore, the higher the gradation density level (approaching 100%), the stronger the dimming effect. A method for determining the gradation density level will be described in detail.

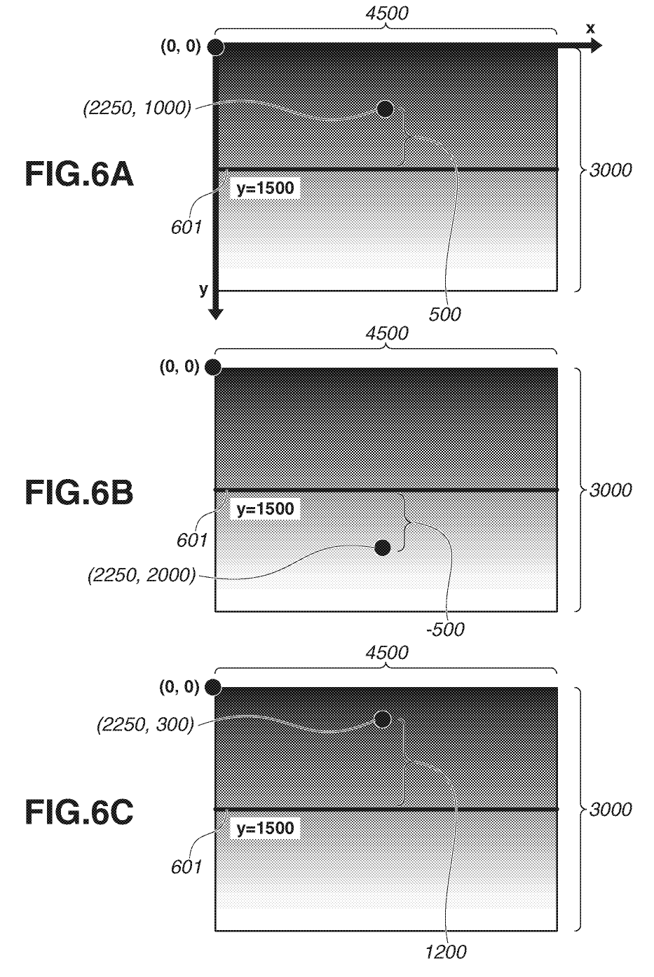

For example, as illustrated in FIGS. 6A to 6C, the effective area of an image is represented by 4500 × 3000, the coordinates of the upper left corner of the image are (0, 0), a gradation center line 601 is a straight line at y = 1500, and the gradation density level at the position of the gradation center line 601 is 50%. Here, it is assumed that the gradation approaches linearly to the dark side in the upward direction along the gradation center line 601 (the direction in which the y coordinate decreases), and that the gradation density level reaches 100% at a distance of 1000.

The gradation approaches linearly to the light side in the downward direction (the direction in which the y coordinate increases) along the gradation center line 601, and the gradation density level reaches 0% at a distance of −1000. In this way, the gradation density level changes depending on the direction of movement (increase or decrease in the y coordinate) with the gradation center line 601 as the boundary.

It is hardly necessary to state that the directions from the gradation center line 601 and the changes in gradation density level are merely examples, and the embodiment is not limited thereto. In addition, various gradation densities that change continuously can be adopted.

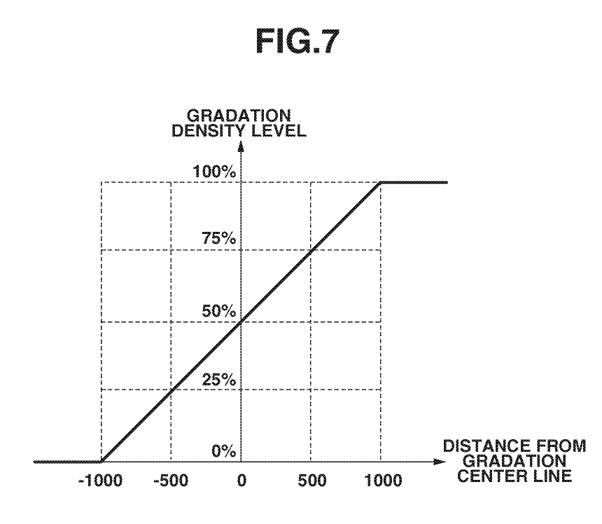

FIG. 7 is a diagram illustrating the relationship between the distance from the gradation center line 601 and the gradation density level in FIGS. 6A to 6C, the gradation density level at coordinates (2250, 1000) is 75% according to FIG. 7 because the distance from the gradation center line 601 to the coordinates (2250, 1000) is 500 as illustrated in FIG. 6A. The gradation density level at coordinates (2250, 2000) is 25% according to FIG. 7 because the distance from the gradation center line 601 to the coordinates (2250, 2000) is −500 as illustrated in FIG. 6B. The distance from the gradation center line 601 to coordinates (2250, 300) is 1200 as illustrated in FIG. 6C. This distance exceeds the distance of 1000 required for the gradation density level to reach 100%. Therefore, the gradation density level at the coordinates (2250, 300) is 100% according to FIG. 7.

In this way, when having determined the gradation density levels for the entire image, the control unit 101 outputs the determined levels as gradation information to the signal processing unit 107. Therefore, the user can output different gradation information by changing the position of the gradation center line 501 on the display unit 109. That is, the user can manipulate the information on the area to be dimmed (dimming area) in the image by changing the position of the gradation center line 501 on the display unit 109.

The gradation center line 601 can be set not only in the vertical direction of the image as illustrated in FIGS. 6A to 6C (the y-axis direction in FIGS. 6A to 6C), but also in the horizontal direction of the image (the x-axis direction in FIGS. 6A to 6C). Also, the gradation center line 601 can be set at any angle around certain coordinates on the image. In this case, the gradation center line 601 is set along the vertical or horizontal direction of the image at a specific angle. At other angles, however, the gradation center line 601 can be set with a very high degree of freedom in its inclination. In this case, the gradation density level may also be determined based on the distance from the gradation center line 601. Furthermore, as illustrated in FIG. 7, the gradation density level may be determined with distinctions among the directions of the distance information with the gradation center line 601 as the boundary.

The characteristics of the gradation may change nonlinearly, unlike the characteristics illustrated in FIG. 7. Furthermore, the gradation density level may be calculated based on the distance from another straight line, rather than the distance from the gradation center line 601. For example, it is possible to prepare a straight line where the gradation density level is 0, such as y = 1500 in FIGS. 6A to 6C, and prepare a gradation that approaches linearly to the dark side in the upward direction (the direction in which the y coordinate is decreased).

It goes without saying that the characteristics of the gradation are not limited to these, and various other characteristics can be provided.

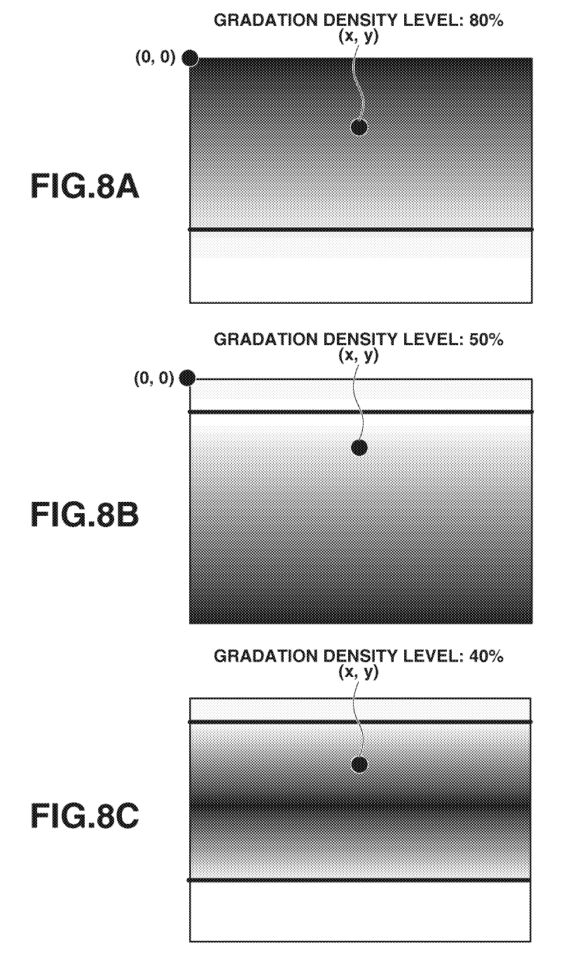

In order to express a gradation as illustrated in FIG. 4B, the gradation illustrated in FIG. 8A and the gradation illustrated in FIG. 8B may be multiplied together to generate gradation information as illustrated in FIG. 8C. That is, a plurality of dimming areas can be set, and the gradation density level can be determined based on the overlapping state of the dimming areas. Also, gradation information may be set for each area rather than for each pixel. The method for multiplying gradations will be described in detail below.

Multiplication of two gradations can be achieved by multiplying the gradation density levels at the same coordinates, for example. For example, the gradation density level at certain coordinates (x, y) illustrated in FIG. 8A is 80%, and the gradation density level at the same coordinates (x, y) illustrated in FIG. 8B is 50%. In this case, the gradation density level obtained by multiplying the two gradations is calculated by multiplying the gradation density levels at the same coordinates (x, y) illustrated in FIG. 8C to obtain 80% × 50% = 40%. In this way, gradation information similar to that from a physical horizon GND filter can be generated.

The method for setting gradation information is not limited to this. For example, three or more gradations may be multiplied. Furthermore, gradation multiplication may be performed not only by multiplication of a plurality of gradation densities but also by addition or subtraction of the same. For example, two gradations, a gradation A with a gradation density level of 50% at certain coordinates (x, y) and a gradation B with a gradation density level of 30% at the same coordinates (x, y) are multiplied together. In this case, the gradation density levels at the same coordinates (x, y) may be added together as 50% + 30% = 80%. Any gradation density level exceeding 100% due to the addition may be handled as 100%. Any gradation density level below 0% due to the subtraction may be handled as 0%.

As described above, various types of gradation information can be generated by multiplying a plurality of gradations.

Next, returning to FIG. 2, the flow after step S202 will be described.

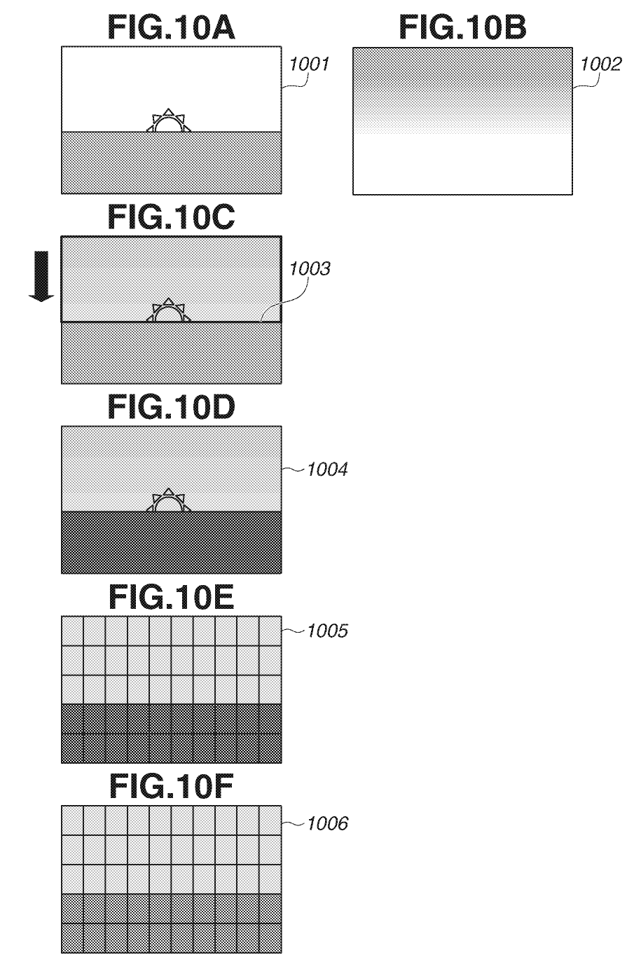

In step S203, the photometry unit 108 acquires a photometric evaluation value. Here, acquisition of a photometric evaluation value from divided exposure images will be described with reference to FIGS. 10A to 10F.

In a scene with an image 1001 illustrated in FIG. 10A, the user uses a GND with a GND density of 4 as illustrated in a GND density distribution diagram 1002 illustrated in FIG. 10B and sets the gradation center line at a position 1003 illustrated in FIG. 10C. In this case, as illustrated in FIG. 3, the control unit 101 performs divided exposure control by decreasing the shutter speed for exposure for ND dimming in order to achieve the effect of a GND filter. The control unit 101 then acquires a RAW image 1004 as illustrated in FIG. 10D and a photometric evaluation value 1005 as illustrated in FIG. 10E from the imaging unit 105.

The acquisition of the photometric evaluation value 1005 will be described in detail. First, the photometry unit 108 acquires the RAW image 1004 acquired by the imaging unit 105. Then, the photometry unit 108 divides the area of the acquired RAW image into a predetermined number of blocks, and integrates pixel signals (brightness values) within the divided areas to calculate the photometric evaluation value. In the example of FIG. 10E, the photometric evaluation value 1005 represents the block integration results obtained by the photometry unit 108 allocating 10 × 5 photometric blocks to the RAW image 1004 and integrating pixel signals within the photometric blocks. For convenience, FIG. 10E represents the block integration results in the individual photometric blocks by gradation of color. The darker the color, the lower the evaluation value as a block integration result (the area is lower in brightness).

The photometric evaluation value has been described as a block integration value obtained by integrating pixel signals (brightness values) in a plurality of pixels in each block. However, the photometric evaluation value is not limited to this, and may be determined by referring to the signal value (brightness value) on a pixel-by-pixel basis, for example.

Subsequently, in step S204, the signal processing unit 107 multiplies the photometric evaluation value acquired in step S203 by gains using the gradation information set by the control unit 101 in step S202. Details of this will be described with reference to FIGS. 10A to 10F.

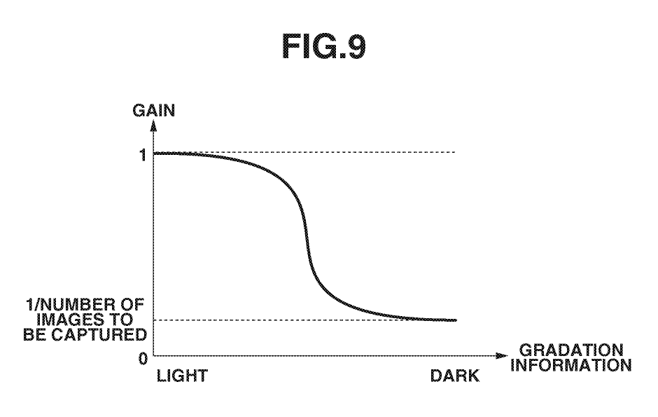

The photometric evaluation value 1005 illustrated in FIG. 10E obtained from the divided exposure images described with reference to step S204 will be lower by the set amount of ND dimming. To correct this, a photometric evaluation value for appropriate photometry is generated by multiplying the photometric evaluation value 1005 by gains calculated from the gradation information as illustrated in FIG. 9. Therefore, after acquisition of the photometric evaluation value 1005 from the photometry unit 108, the signal processing unit 107 multiplies the same by the gains calculated from the gradation information to generate a photometric evaluation value 1006 as illustrated in FIG. 10F. This makes it possible to generate a photometric evaluation value equivalent to the photometric evaluation value acquired from a GND composite image.

The maximum value of the gain to be multiplied is 1, and the minimum value is "1/the number of images to be captured". As illustrated in FIG. 9, the gains are calculated from the gradation information and then are used for multiplication. For example, the gain for the lightest part of the gradation is 1, and the gain for the darkest part of the gradation is "1/the number of images to be captured". However, the method for calculating gains from the gradation information is not limited to this.

The method for multiplying the photometric evaluation value by gains has been described. Alternatively, a RAW image may be multiplied by gains and then may be converted into a photometric evaluation value. Alternatively, a RAW image may be developed into a YUV image, and the YUV image may be multiplied by gains and then may be converted into a photometric evaluation value.

In any case, the means for generating a photometric evaluation value is not limited to that in the embodiment as long as a photometric evaluation value can be generated from pixel signals (brightness values) by any other method.

Next, in step S205, the control unit 101 determines whether the photometry unit 108 should perform exposure control such that the gradation area set in step S202 reaches the target exposure. In the case of performing light metering in the gradation area (YES in step S205), step S205 is executed, and in the case of performing light metering in an area outside the gradation area (NO in step S205), step S206 is executed.

The control unit 101 determines in step S205 whether the exposure control should be performed such that the gradation area reaches the target exposure, depending on whether a mode in which light metering in the gradation area is prioritized (focused on) (ND area-prioritized photometry mode) is set on the imaging apparatus 100, for example. If the control unit 101 determines that the ND area-prioritized photometry mode is set, the processing in step S205 is performed.

The photometry mode can be set via the operation unit 111 or the like. Alternatively, the control unit 101 may perform control to display a photometry mode setting screen on the display unit 109 or the like in response to a predetermined operation so that the user can touch the screen to select a mode, thereby enabling the photometry mode to be set.

Examples of photometry modes that can be set include a center-weighted photometry mode, an evaluation photometry mode, a spot photometry mode, and the like. The center-weighted photometry mode is a mode in which the brightness of an image is measured (metered) while the highest weight is given to the brightness (luminance) of the center of the image and the weight of brightness is decreased as proximity to the periphery is increased. The evaluation photometry mode is a mode in which the brightness of an image is calculated (light metering is performed) while the brightness of the entire image is averaged. The spot photometry mode is a mode in which the brightness of an image is calculated (light metering is performed) while a higher weight to a specific area such as the focus point.

In the ND area-prioritized photometry mode in the embodiment, light metering in the set gradation area is prioritized. Also, in the ND area-prioritized photometry mode, no light metering is performed in an area outside the gradation area, or light metering is performed in an area outside the gradation area with its weight (for example, a weighting coefficient is set between 0 and 1) set to a smaller value (the weight may be set to 0) than that of the gradation area. This makes it possible to perform light metering with less influence of the evaluation value outside the gradation area.

The embodiment may also include a mode in which light metering in the non-gradation area is prioritized (non-ND area-prioritized photometry mode). In the non-ND area-prioritized photometry mode, light metering in the area other than the set gradation area is prioritized. Also, in the non-ND area-prioritized photometry mode, no light metering is performed in the gradation area, or light metering is performed in the gradation area with its weight (for example, a weighting coefficient is set to a value between 0 and 1) set to a smaller value (the weight may be set to 0) than that of the non-gradation area. This makes it possible to perform light metering while reducing the influence of the evaluation value of the gradation area. In this case, if the control unit 101 determines in step S204 that the ND area-prioritized photometry mode is set, the process may proceed to step S206.

In the embodiment, when setting gradation information in step S202, the ND area-prioritized photometry mode or the non-ND area-prioritized photometry mode may be set. This allows the user to selectively set in advance the area for which he/she wishes to set the target exposure, taking gradation into consideration.

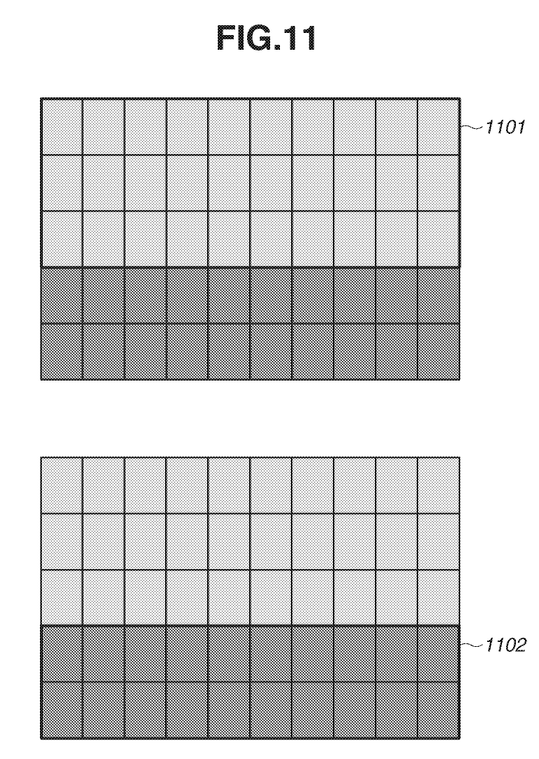

In step S206, the photometry unit 108 calculates the photometric value in the photometry area corresponding to the gradation area from the photometric evaluation value 1006 generated in step S204. For example, if the user sets the gradation center line to the position 1003 in FIG. 10C, the corresponding photometry area will be 1101 in FIG. 11A. Here, the image is divided into predetermined areas (blocks) corresponding to the gradation center line. FIG. 11A explicitly illustrates the area to be subjected to light metering this time (gradation area).

Meanwhile, in step S207, the photometric value in the photometry area corresponding to the area outside the gradation area is calculated from the photometric evaluation value 1006 generated in step S204, as illustrated at 1102 in FIG. 11B. For example, if the user sets the gradation center line to the position 1003 in FIG. 10C, the photometry area corresponds to 1102 in FIG. 11B. Here, the image is divided into predetermined areas (blocks) corresponding to the gradation center line. FIG. 11B explicitly illustrates the area to be subjected to light metering this time (non-gradation area).

In the above-described embodiment, the photometric value in the corresponding area is calculated after determining whether to perform light metering in the gradation area or the area outside the gradation area. However, the embodiment is not limited to this. For example, the photometric value in the area corresponding to the gradation area and the photometric value in the area outside the gradation area may be calculated in advance from the photometric evaluation value, and the photometric value for use in exposure control may be changed depending on the set photometry area. In this case, the photometric value in the area corresponding to the gradation area and the photometric value in the area outside the gradation area are both calculated in step S204, and the process proceeds to step S207 (described below) to select the photometric value for use in exposure control. At this time, the photometric value may be selected according to the photometry mode (ND area-prioritized photometry mode or non-ND area-prioritized photometry mode) set in advance in the imaging apparatus 100. Alternatively, the user may be allowed to select the photometric value in step S207.

In step S208, automatic exposure control is performed based on the photometric value calculated in step S206 or step S207 to achieve target exposure determined to be appropriate by automatic exposure control or target exposure determined by the user through exposure correction. Specifically, automatic exposure is achieved by adjusting exposure control values such as shutter speed, aperture, and ISO sensitivity, which are exposure conditions for capturing an image by the imaging apparatus 100, to match the target exposure.

According to the above-described embodiment, it is possible to perform exposure control by selectively performing light metering so as to set the gradation area or the area outside the gradation area to the target exposure.

### Other Embodiments

The disclosure can also be carried out by supplying a program for implementing one or more functions of the above-described embodiment to a system or a device via a network or a recording medium, and causing one or more processors in a computer of the system or device to read and execute the program. The disclosure can also be implemented by a circuit that implements one or more functions (for example, an application specific integrated circuit (ASIC)).

According to the disclosure, it is possible to selectively perform light metering in an area that has been dimmed by image processing or an area that has not been dimmed in a captured image, and perform exposure control to achieve target exposure.

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-078493, filed May 9, 2025, which is hereby incorporated by reference herein in its entirety.

What is claimed is:

1. An apparatus comprising:
at least one processor; and
a memory that stores a program which, when executed by the at least one processor, causes the at least one processor to function as:
an acquisition unit configured to acquire an image;
a setting unit configured to set an area in the image to which a dimming effect is to be applied;
a calculation unit configured to calculate an evaluation value for the image;
a photometry unit configured to perform light metering on the image; and
a correction unit configured to correct the evaluation value based on a setting of the area,
wherein the photometry unit uses the corrected evaluation value to perform light metering on a priority based on either the area or an area other than the area.

2. The apparatus according to claim 1, further comprising a mode setting unit configured to set a photometry mode,
wherein the photometry unit performs light metering based on a priority in either the area to which the dimming effect is to be applied or an area other than the area to which the dimming effect is to be applied, in accordance with the photometry mode.

3. The apparatus according to claim 1, further comprising an input unit configured to accept a user's operation,
wherein the setting unit changes the area to which the dimming effect is to be applied in response to the user's operation on the input unit.

4. The apparatus according to claim 1,
wherein the setting unit is capable of setting a plurality of areas to which the dimming effect is to be applied, and
wherein the correction unit changes the correction of the evaluation value in accordance with an overlap between the plurality of set areas to which the dimming effect is to be applied.

5. The apparatus according to claim 1, wherein the area to which the dimming effect is to be applied has an area that changes continuously in a predetermined direction of the image.

6. The apparatus according to claim 5, wherein the predetermined direction is an up-and-down direction, a right-and-left direction, or another direction at an arbitrary angle of the image.

7. The apparatus according to claim 1, wherein the photometry unit assigns different weights in the light metering to the area to which the dimming effect is to be applied and the area other than the area to which the dimming effect is to be applied.

8. The apparatus according to claim 1,
wherein the setting unit is capable of changing an intensity of the dimming effect, and
wherein the correction unit corrects the evaluation value based on the intensity.

9. The apparatus according to claim 1, wherein the setting unit sets the area to which the dimming effect is to be applied in order to simulate an effect of a half neutral density (ND) filter.

10. The apparatus according to claim 1, further comprising an exposure setting unit configured to determine an exposure control value based on a result of the light metering.

11. The apparatus according to claim 10, wherein the exposure control value includes at least one of a shutter speed, an aperture value, and International Organization for Standardization (ISO) sensitivity.

12. An imaging apparatus comprising:
an imaging unit;
an exposure control unit configured to control exposure; and
the apparatus according to claim 11.

13. The imaging apparatus according to claim 12, wherein the exposure control unit controls the exposure based on the determined exposure control value.

14. A method of an apparatus, comprising:
acquiring an image;
setting an area in the image to which a dimming effect is to be applied;
calculating an evaluation value for the image;
performing light metering on the image; and
correcting the evaluation value based on a setting of the area to which the dimming effect is to be applied,
wherein, in the performing light metering, the corrected evaluation value is used to perform the light metering on a priority basis in either the area to which the dimming effect is to be applied or an area other than the area to which the dimming effect is to be applied.

15. The method according to claim 14, further comprising setting a photometry mode,
wherein the performing performs light metering based on a priority in either the area to which the dimming effect is to be applied or an area other than the area to which the dimming effect is to be applied, in accordance with the photometry mode.

16. The method according to claim 14, further comprising accepting a user's operation,
wherein the setting unit changes the area to which the dimming effect is to be applied in response to the user's operation on the input unit.

17. A non-transitory computer-readable storage medium storing a program for causing a computer to perform a method, the method comprising:
acquiring an image;
setting an area in the image to which a dimming effect is to be applied;
calculating an evaluation value for the image;
performing light metering on the image; and
correcting the evaluation value based on a setting of the area to which the dimming effect is to be applied,
wherein, in the performing light metering, the corrected evaluation value is used to perform the light metering on a priority basis in either the area to which the dimming effect is to be applied or an area other than the area to which the dimming effect is to be applied.

18. The non-transitory computer-readable storage medium according to claim 17, further comprising setting a photometry mode,
wherein the performing performs light metering based on a priority in either the area to which the dimming effect is to be applied or an area other than the area to which the dimming effect is to be applied, in accordance with the photometry mode.

19. The non-transitory computer-readable storage medium according to claim 17, further comprising accepting a user's operation,
wherein the setting unit changes the area to which the dimming effect is to be applied in response to the user's operation on the input unit.
